(19) United States
(12) Patent Application Publication
(10) Pub. No.: US 2011/0297617 A1
(43) Pub. Date: Dec. 8, 2011

(54) SEPARATOR AND METHOD

(75) Inventor: Oleg A. Mazyar, Houston, TX (US)

(73) Assignee: BAKER HUGHES INCORPORATED, Houston, TX (US)

(21) Appl. No.: 12/793,296

(22) Filed: Jun. 3, 2010

(51) Int. Cl. B01D 33/052; B01D 33/46; B01D 33/048

(52) U.S. Cl. 210/670; 210/401; 210/386; 210/396

(57) ABSTRACT

A separator includes a separation arrangement having a roller; and a belt disposed about the roller. Feed material introduced to the separator such as tar sand, is separated into sand and oil so that discharge from the separator will be substantially separate material streams of sand and oil. A method and system are included.

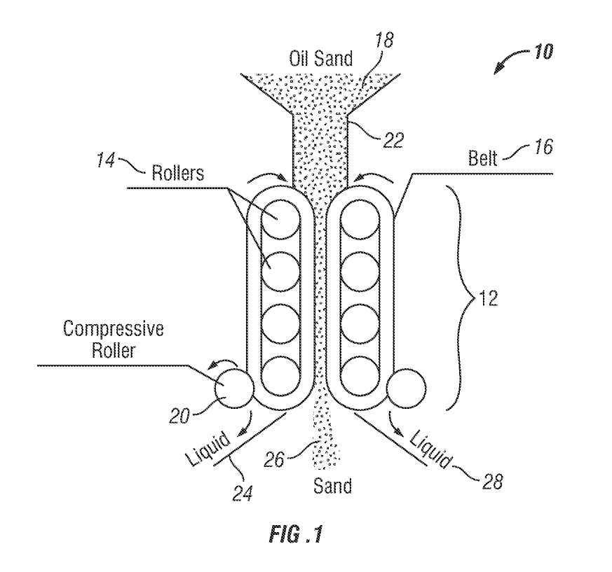

### BACKGROUND

In the hydrocarbon industry, it is common to have desirable fluids intermingled with undesirable fluids and or solids. Of particular of financial temptation but practical frustration are oil sands. One of skill in the art will be readily familiar with both the desire to and inability to economically recover oil from oil sands. There is a vast oil reserve in oil sands such as in Alberta, Canada. Although many methods have been used to recover the oil effectively, they have generally brought disappointing results due both to its viscosity and the inherent sand contamination of the target hydrocarbon. Traditional well drilling is insufficient because the bitumen is too viscous to flow. Commonly then strip mining procedures are used to remove the oil and sand together from the deposit. Since the oil is generally homogenously mixed with the sand, significant and expensive processing is required to remove the sand from the mined combination. The conundrum presented by the sand being produced with the target fluid is two fold. First, the sand will have to be removed by the further processing which processing heretofore adds great expense to the operation; and second, is the environmental impact of excavated sand that is contaminated with oil. It is not environmentally sensitive to dump oil contaminated sand at the surface, and is generally not in compliance with applicable regulations either. Consequently, the sand must be cleaned too.

For the foregoing reasons, oil sands have been more vexing than they are a resource. In view of the significant potential for hydrocarbon recovery however, the art would well receive a technology that improves the potential for economically favorable collection of hydrocarbons from oil sands.

### SUMMARY

A separator includes a separation arrangement including a roller; and a belt disposed about the roller.

A method for separating a fluid constituent from particulate material mixed therewith includes introducing a particulate material and fluid combination to a separator includes a separation arrangement including a roller; and a belt disposed about the roller; one or more of absorbing and adsorbing a target fluid into the belt; and squeezing the target fluid out of the belt at a position preselected to separate the fluid.

A system for separating a fluid from a volume including a first separator includes a separation arrangement including a roller; and a belt disposed about the roller; a second separator includes a separation arrangement including a roller; and a belt disposed about the roller, the second separator being positioned to accept a feed material from an exit of the first separator.

### BRIEF DESCRIPTION OF THE DRAWINGS

Referring now to the drawing wherein like elements are numbered alike in the FIGURE:

The FIGURE is a schematic view of a separator as described herein.

### DETAILED DESCRIPTION

Referring to the FIGURE, a separator 10 is illustrated having one or more separation arrangements 12 comprising rollers 14 supporting a belt 16. In the illustrated embodiment there are two separation arrangements 12. The rollers 14 function to support the belt(s) 16 while positioning the same to bear against a quantity of oil sand, for example, moving through the separator 10. It is to be understood that although the rollers 14 number four in each arrangement as illustrated the number of rollers 14 is not limited to that number nor even to that configuration. More or fewer rollers 14 may be employed and they may be configured linearly as illustrated or non-linearly. Moreover, the separator may be configured to be hundreds of feet in either its direction of motion or laterally to that direction of motion. More or fewer rollers may be employed to support the belt(s) 16 as needed. Positioning of the arrangements may be against one another or one against some other structure. The separator 10 will perform more effectively for a longer period of time if an arrangement is at least operating against another rolling device whether or not it be a separating arrangement. For example, while the separator will work with an arrangement positioned against a non-moving plate (not shown), the plate will experience rapid abrasive deterioration due to being constantly sanded. Such a configuration while being effective for the purpose of separating constituents of oil sand in accordance with the construction of one of the arrangements disclosed herein will have an abbreviated useful life. A separating arrangement against another separating arrangement is most effective.

The rollers function to allow the belts to move and maintain the selected location of the belts especially relative to another arrangement 12. The belt or belts 16 comprise a material that has an affinity to one or more fluid components of a feed stock 18 that will be fed to the separator 10. In one embodiment the belt(s) 16 have an affinity for oil. In another embodiment, the material of the belt not only has an affinity to a particular fluid but one may also have a phobicity to one or more other fluids. More specifically, in the event that a belt material is selected that for, example, has an affinity to oil, and also has a hydrophobicity, water will be more readily excluded from the desired hydrocarbon target fluid. The water, due to the hydrophobicity, will be rejected from the belts along with the sand. The belts 16 will be addressed more fully later in this specification.

Still referring to the FIGURE, the separator 10 further includes a compression roller 20 for each arrangement 12. The compression roller functions to squeeze the belt(s) 16 to liberate absorbed or adhered fluid therein. It will be noted that a hopper 22 is illustrated to feed a feed stock 18 to the arrangement(s), in one embodiment, oil sand. Feed stock 18 is pressed between the arrangements 12 so that oil is absorbed/adhered to the belts 16. That oil is then mechanically squeezed back out of the belts 16 and allowed to collect in a collection system, not shown. It will be understood that alternate feed configurations are contemplated.

Finally, in some embodiments, a scraper 24 is associated with one or more of the arrangements 12. The scraper 24 is configured to remove particulate matter from the belts 16. Removal is due to the scraper 24 being positioned to dislodge the particulate aggregate on a surface of the belts 16. The scraper 24 may be positioned to compress the belts 16 somewhat for a more aggressive cleaning of the aggregated particulate matter or to scrape the surface or not even touch the surface. In some embodiments the position of the scraper relative to the belt is adjustable. Adjustability is to be accomplished using conventional methods to adjust a position and attitude of a member such as a plate. The scraper itself may be of blade form or may be of brush form or may be both for various applications.

It is noted that the illustration may be viewed as producing desired cleaned sand or as producing desired fluid separated from undesired particulate material. Stated alternately, output 26, which is illustrated as particulate material may be the target material or may be the material to be removed from the target material. Likewise, output 28 may be the target material or the material to be removed from the target material. In addition, both outputs may be target material in some embodiments. In the FIGURE, both outputs are target outputs. In the illustrated embodiment, the point is to produce both particulates that are cleaned of oil and oil that is cleaned of particulates. In this way, oil sands can be effectively and economically produced.

Referring to the belts 16, they may be constructed of any target fluid absorptive or adsorptive material such as foam, felt, other woven or nonwoven textile, etc. and combinations including at least one of the foregoing. In one embodiment the material may be a foam having a closed cell structure, partly open cell structure, or may have an open cell structure providing that fluid absorption or adherence is possible. Interstices in the foam should be smaller than the size of the particulate matter that is intended to be disassociated from the fluids. In this way, it will be unlikely that particulate matter can work its way through the foam and rejoin the fluid. In one embodiment of the separator 10 disclosed herein the material is a Polyurethane foam such as a polycarbonate polyurethane foam. This foam is resistant to hydrocarbon exposure and resistant to abrasion. The foam is an open cell foam and generally is of solid consistency at room temperature but is quite flexible at elevated temperature. In view of the potential use of the separator 10 for viscous bitumen sands that must have their temperature elevated for processing, this foam functions well for its intended purpose. Many grades of Polyurethane rigid foam are available commercially from many sources having varying properties that can be capitalized upon with consideration of the particular application intended. Some properties generally useful with respect to many embodiments of the concept disclosed herein include the following: reasonably flexible at a temperature at which it will be used, and affinity for one or more target fluids. For Example, in some embodiments contemplated for use in the hydrocarbon production industry flexibility of the material at about 70 to about 80 C. is helpful. Further, a glass transition onset temperature of the foam should be about 5-15 degrees C. above a temperature at which processing is expected to be carried out. This allows the foam to be flexible yet still stiff enough to recover its shape after being squeezed. Other materials that may be configured as foams, that may be used in conjunction with the separator include but are not limited to polyethylene, ethylene-vinyl acetate copolymer, polypropylene, polyvinylchloride, and polyphenyleneoxide blend with polystyrene. Other alternative materials include but are not limited to bead foams comprising ethylene styrene interpolymers-low density polyethylene blends or ethylene styrene interpolymers-ethylene-vinyl acetate copolymer blends.

The belts 16 may be constructed entirely of the absorbent or adsorbent material or may be bonded or otherwise attached to a base material such as rubber for strength. Other materials may also be substituted for the base material such as metal belt structures to which the absorbent or adsorbent material is secured as the base material is only for strength and otherwise not important to function of the separator. Further, it is to be understood that the belt may be continuous over its length or may be segmented with segments being relatively close together. Segmented belts may improve belt flexibility, especially with respect to roller diameter at direction change regions of the belt movement.

The terms “first,” “second,” and the like, herein do not denote any order, quantity, or importance, but rather are used to distinguish one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While it is now clear that the separator is employable to help extract desired hydrocarbon fluids from oil sands and the like, it should also be noted that the separator is employable as an environmental clean up tool. Once it has been determined what fluid is a contaminant of a target cleanup site, an appropriate foam having an affinity for that fluid can be selected and then the soil, sand or similar particulate from the site can be caused to move through the separator yielding cleaned soil and recovered pollutants.

It is to be understood that although the invention has been described above in the singular, it is contemplated that a series of two or more separators may be employed together to efficiently process volumes of target material. Moreover, systems of two or more separators are contemplated that may be absorptive of different fluids. For example, a system might have a first separator having an affinity to water and a second separator having an affinity to oil. By creating such systems, a multitude of fluids can be removed from a target material efficiently.

While one or more embodiments have been shown and described, modifications and substitutions may be made thereto without departing from the spirit and scope of the invention. Accordingly, it is to be understood that the present invention has been described by way of illustrations and not limitation.

1. A separator comprising:
a separation arrangement comprising:
a roller; and
a belt disposed about the roller.

2. A separator as claimed in claim 1 further comprising a hopper configured and positioned to provide a feed stock to the separation arrangement.

3. A separator as claimed in claim 1 wherein the roller is a set of rollers supporting the belt along a length of movement of the belt.

4. A separator as claimed in claim 1 wherein the roller is a set of rollers supporting the belt along a width of the belt generally perpendicular to a direction of movement of the belt.

5. A separator as claimed in claim 1 wherein the belt comprises a material that is one or more of absorbent or adsorbent to a target fluid.

6. A separator as claimed in claim 5 wherein the material is phobic to a constituent that is not a target fluid.

7. A separator as claimed in claim 5 wherein the target fluid is a production product.

8. A separator as claimed in claim 5 wherein the target fluid is oil.

9. A separator as claimed in claim 5 wherein target fluid is a pollutant.

10. A separator as claimed in claim 1 wherein the belt comprises a foam material.

11. A separator as claimed in claim 10 wherein the foam is open cell foam.

12. A separator as claimed in claim 10 wherein the foam is polyurethane foam.

13. A separator as claimed in claim 1 further comprising a compression roller in compressive contact with the belt.

14. A separator as claimed in claim 13 wherein the compression roller squeezes target fluids from the belt.

15. A separator as claimed in claim 1 further comprising a scraper in operable communication with the belt to dislodge particulate aggregate therefrom in use.

16. A method for separating a fluid constituent from particulate material mixed therewith comprising:
introducing a particulate material and fluid combination to a separator as claimed in claim 1;
one or more of absorbing and adsorbing a target fluid into the belt; and
squeezing the target fluid out of the belt at a position preselected to separate the fluid.

17. A method for separating a fluid constituent from particulate material mixed therewith as claimed in claim 16 wherein the method further comprises scraping the particulate material off the belt.

18. A method for separating a fluid constituent from particulate material mixed therewith as claimed in claim 16 wherein the method further comprises phobically rejecting nontarget fluid from the belt.

19. A method for separating a fluid constituent from particulate material mixed therewith as claimed in claim 16 further comprising scraping aggregated particulate material from the belt.

20. A system for separating a fluid from a volume comprising:
a first separator as claimed in claim 1;
a second separator as claimed in claim 1, the second separator being positioned to accept a feed material from an exit of the first separator.

21. A system as claimed in claim 20 wherein the belt of the first separator has an affinity for a first fluid and the belt of the second separator has an affinity for a second fluid different from the first fluid.
